(19) United States
(12) Patent Application Publication
(10) Pub. No.: US 2015/0156356 A1
(43) Pub. Date: Jun. 4, 2015

(54) IMAGE CORRECTION DEVICE AND IMAGE CORRECTION METHOD THEREOF

(71) Applicant: Foxlink Image Technology Co., Ltd., New Taipei City (TW)

(72) Inventors: Yao Shuo Chang, New Taipei City (TW); Pin Kuan Chou, New Taipei City (TW)

(73) Assignee: Foxlink Image Technology Co., Ltd., New Taipei City (TW)

(21) Appl. No.: 14/093,180

(22) Filed: Nov. 29, 2013

(51) Int. Cl. H04N 1/00; H04N 1/12

(52) U.S. Cl. CPC H04N 1/00652; H04N 1/00657; H04N 1/00588; H04N 1/121

(57) ABSTRACT

An image correction device includes an input tray, a pickup roller, a separation roller, a plurality of first and second feed rollers, a scanning area, a sensor unit, a control unit, a plurality of paper-out rollers and a paper-out tray. The control unit electrically connects with the sensor unit and controls rotating speeds of the first and second feed rollers. An image correction method of image correction device is described hereinafter. When the paper is going to pass through the scanning area, the sensor unit sends a first signal to the control unit, when the sensor unit detects a transmitting status or a transmitting speed of the paper to be changed, the sensor unit sends a second signal to the control unit for modulating rotating speeds of the first and second feed rollers and the transmitting speed of the paper until the paper is scanned completely.

### BACKGROUND OF THE INVENTION

1. Field of the Invention

The present invention generally relates to an image correction device and an image correction method thereof, and more particularly to an image correction device applied to an automatic feed type scanner and an image correction method thereof

2. The Related Art

Referring to FIG. 1 to FIG. 3, in general, a traditional automatic feed type scanner 100′ includes an input tray 21′for loading papers 40′ therein, a pickup roller 22′, a separation roller 23′, a plurality of first feed rollers 24′, a plurality of second feed rollers 25′, a transmitting path 10′, a plurality of paper-out rollers 26′, a paper-out tray 27′ and a scanning area 30′. The pickup roller 22′ is disposed above the input tray 21′ for picking up the papers 40′, and the separation roller 23′ is disposed to an entry end of the transmitting path 10′ for separating the papers 40′ to ensure the papers 40′ transmitted to the transmitting path 10′ piece by piece. The first feed rollers 24′ are disposed in upstream of the transmitting path 10′ and the second feed rollers 25′ are disposed in downstream of the transmitting path 10′. The first feed rollers 24′ and the second feed rollers 25′ continuously transmit papers 40′ to be under the scanning area 30′. The scanning area 30′ reads text or image of the paper 40′. In order to make the papers 40′ keep flat in the process of transmitting the papers 40′, in the process of designing the automatic feed type scanner 100′, rotating speed of the second feed rollers 25′ will be designed to be faster than that of the first feed rollers 24′. The papers 40′ are stretched flat by virtue of a speed difference of the first feed rollers 24′ and the second feed rollers 25′.

Referring to FIG. 2 and FIG. 3, when the papers 40′ pass through the scanning area 30′, the scanning area 30′ retrieves one line of image perpendicular to a direction of transmitting the papers 40′. The one line of the image is designated as a scanning line 50′. Because the scanning area 30′ photographs and samples the image on the paper 40′ at a constant frequency, a distance between each two scanning lines 50′ is constant. After the image on the paper 40′ is photographed and sampled, the scanning lines 50′ are combined into a complete image by virtue of a subsequent procession. Then the first feed rollers 24′ and the second feed rollers 25′transmit the paper 40′ to the paper-out rollers 26′. At last, the paper-out rollers 26′ transmit the paper 40′ out of the transmitting path 10′ to the paper-out tray 27′.

Referring to FIG. 3, because the complete image is composed of all the scanning lines 50′, so when the transmitting speed of the papers 40′ speeds up or slows down, a distance between each two scanning lines 50′ will be decreased or lengthened, and the combined image will generate an abnormal proportion. One moment tail edges of the papers 40′ break away from the first feed rollers 24′, the papers 40′ generate an instantaneous acceleration because of a rotating speed of the second feed rollers 25′ being faster that makes the transmitting speed of the papers 40′ apt to be changed.

In order to avoid the combined image to generate an abnormal proportion, the traditional automatic feed type scanner 100′ use various different means for avoiding generating a speed variation in the process of the tail edges of the papers 40′ breaking away from the first feed rollers 24′ and the second feed rollers 25′. For example, U.S. Pat. No. 3,988,817 discloses using different materials to make third feed rollers (not shown), it makes the process of the tail edges of the first documents (not shown) breaking away from the third feed rollers (not shown) smoothly for further avoiding the first documents speeding up suddenly. In addition, U.S. Pat. No. 6,530,569 discloses an actuating device (not shown) disposed to a fourth feed roller (not shown), when a tail edge of second document is ready to break away from the fourth feed roller, the fourth feed roller is released for avoiding the second document accelerating suddenly.

However, U.S. Pat. No. 3,988,817 discloses that the third feed roller generates a poor performance in the condition of the third feed roller being used in a long time. And U.S. Pat. No. 6,530,569 discloses that the method of disposing the actuating device to the fourth feed roller increases manufacturing cost. In view of the above-mentioned drawbacks, it's essential to improve the traditional automatic feed type scanner 100′ for providing an image correction device which is apt to be manufactured and maintained and an image correction method of the image correction device.

### SUMMARY OF THE INVENTION

An object of the present invention is to provide an image correction device adapted for being applied to an automatic feed type scanner. The automatic feed type scanner defines a transmitting path for feeding papers. The image correction device includes an input tray, a pickup roller, a separation roller, a plurality of first feed rollers, a plurality of second feed rollers, a scanning area, a sensor unit, a control unit, a plurality of paper-out rollers and a paper-out tray. The input tray is disposed adjacent to the transmitting path for loading the papers therein. The pickup roller is disposed above the input tray for picking up the papers. The separation roller is disposed to an entry end of the transmitting path for separating the papers to ensure the papers transmitted to the transmitting path piece by piece. The first feed rollers are disposed in upstream of the transmitting path for transmitting the papers in the transmitting path. The second feed rollers are disposed in downstream of the transmitting path for transmitting the papers in the transmitting path. The scanning area is disposed to the transmitting path and located between the first feed rollers and the second feed rollers for scanning papers. The sensor unit is disposed to the transmitting path for detecting a position of the paper and a distance between each two pieces of paper. The control unit electrically connects with the sensor unit and controls rotating speeds of the first feed rollers and the second feed rollers according to signals sending by the sensor unit. The paper-out rollers are disposed to an exit end of the transmitting path for transmitting the paper out of the transmitting path. The paper-out tray is disposed under the paper-out rollers to load the paper transmitted out of the transmitting path.

Another object of the present invention is to provide an image correction method of image correction device. The image correction method of image correction device is described hereinafter. The pickup roller picks up the papers loaded in the input tray. The separation roller separates the papers to ensure the papers transmitted to the transmitting path piece by piece. The first feed rollers and the second feed rollers transmit the papers in the transmitting path. The sensor unit starts monitoring the position and the transmitting speed of the paper. When the paper is going to pass through the scanning area, the sensor unit sends a first signal to the control unit to control the scanning area to start scanning the papers, when the sensor unit detects a transmitting status or a transmitting speed of the paper to be changed, the sensor unit sends a second signal to the control unit for modulating rotating speeds of the first feed rollers and the second feed rollers and the transmitting speed of the paper until the paper is scanned completely to make the image on the paper photographed and sampled, and the paper is apart away from the scanning area.

Another object of the present invention is to provide a method of changing the rotating speeds of the first feed rollers and the second feed roller. The method of changing the rotating speeds of the first feed rollers and the second feed roller is described hereinafter. The sensor unit detects a front edge of the paper, and the front edge of the paper triggers the sensor unit to make the sensor unit send the first signal to the control unit. When the control unit receives the first signal, the control unit controls the scanning area to start scanning the paper. When the sensor unit detects the tail edge of the paper to break away from the first feed rollers, the sensor unit sends the second signal to the control unit. When the control unit receives the second signal, the control unit is going to control the rotating speed of the second feed roller to be lowered to maintain a constant transmitting speed of the paper.

As described above, the image correction device modulates the rotating speeds of the first feed rollers and the second feed rollers by virtue of the sensor unit detecting the position of the paper for effectively preventing the transmitting speed of the paper from being changed. Comparing with the prior art, the image correction device in accordance with the present invention needs no extra device, and it effectively prevents the image correction device generates an error after the image correction device being used to generate an abrasion. Therefore, the image correction device is apt to manufacture and maintain and an image correction method of the image correction device is provided.

### BRIEF DESCRIPTION OF THE DRAWINGS

The present invention will be apparent to those skilled in the art by reading the following description, with reference to the attached drawings, in which:

FIG. 1 is a schematic diagram of an automatic feed type scanner in prior art;

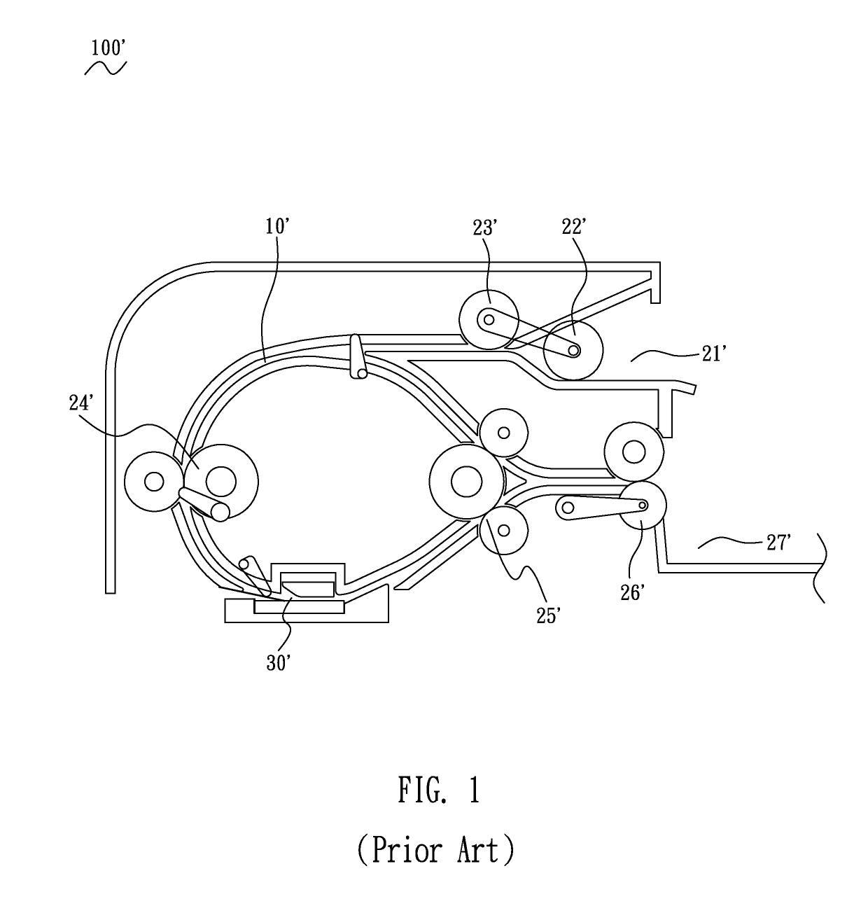

FIG. 2 is a schematic diagram of the automatic feed type scanner of FIG. 1, wherein transmitting speed of the paper is changed that causes an image abnormality;

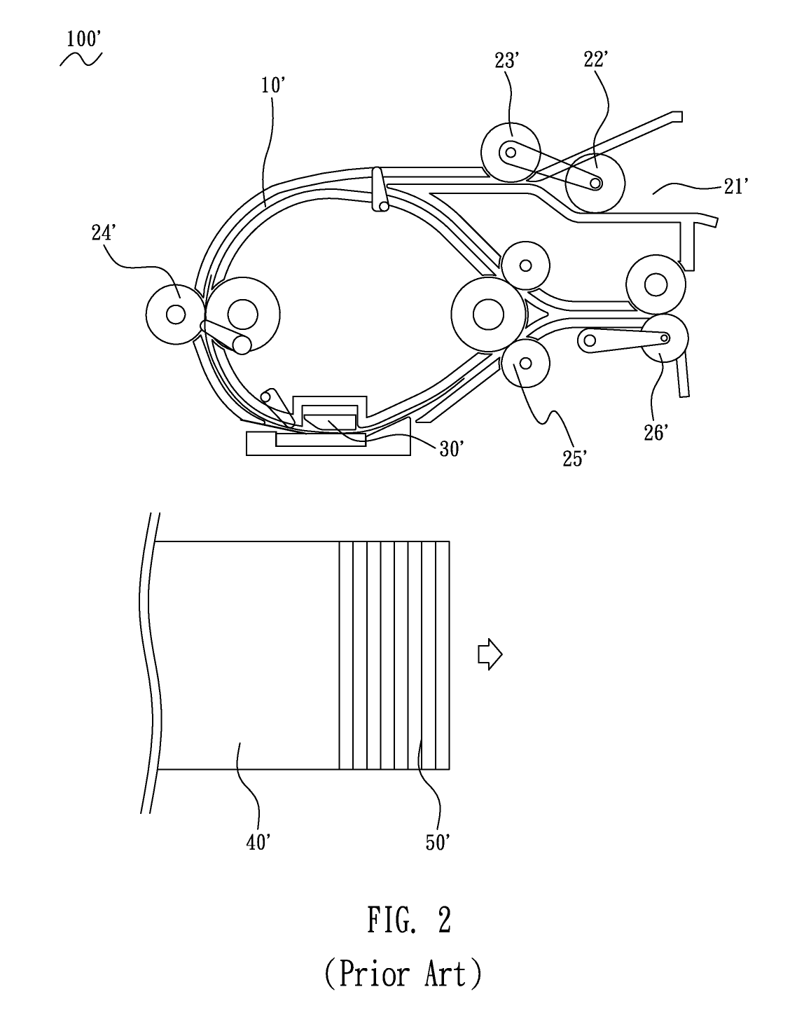

FIG. 3 is another schematic diagram of the automatic feed type scanner of FIG. 1, wherein the transmitting speed of the paper is changed that causes the image abnormality;

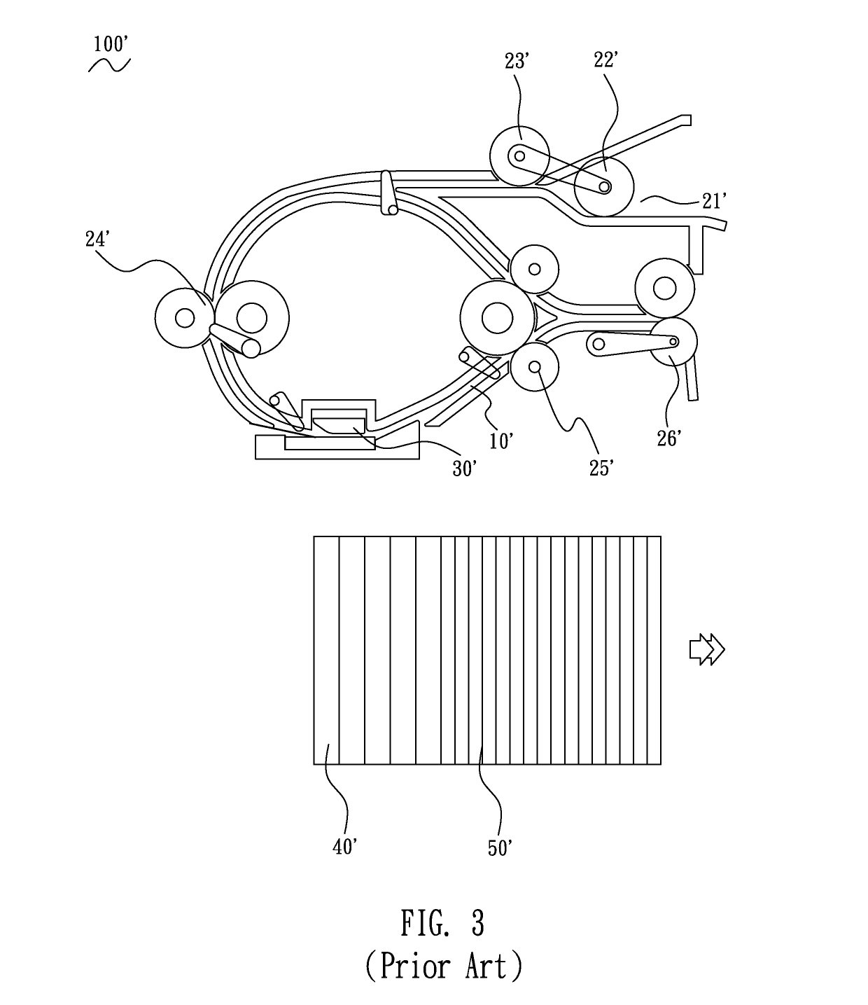

FIG. 4 is a schematic diagram of an image correction device in accordance with an embodiment of the present invention;

FIG. 5 is a correction flowchart of an image correction method of image correction device in accordance with the embodiment of the present invention;

FIG. 6 is a schematic diagram of the image correction device of FIG. 4, wherein the image correction device starts scanning; and

FIG. 7 is a schematic diagram of the image correction device of FIG. 4, wherein the image correction device completes scanning

### DETAILED DESCRIPTION OF THE PREFERRED EMBODIMENT

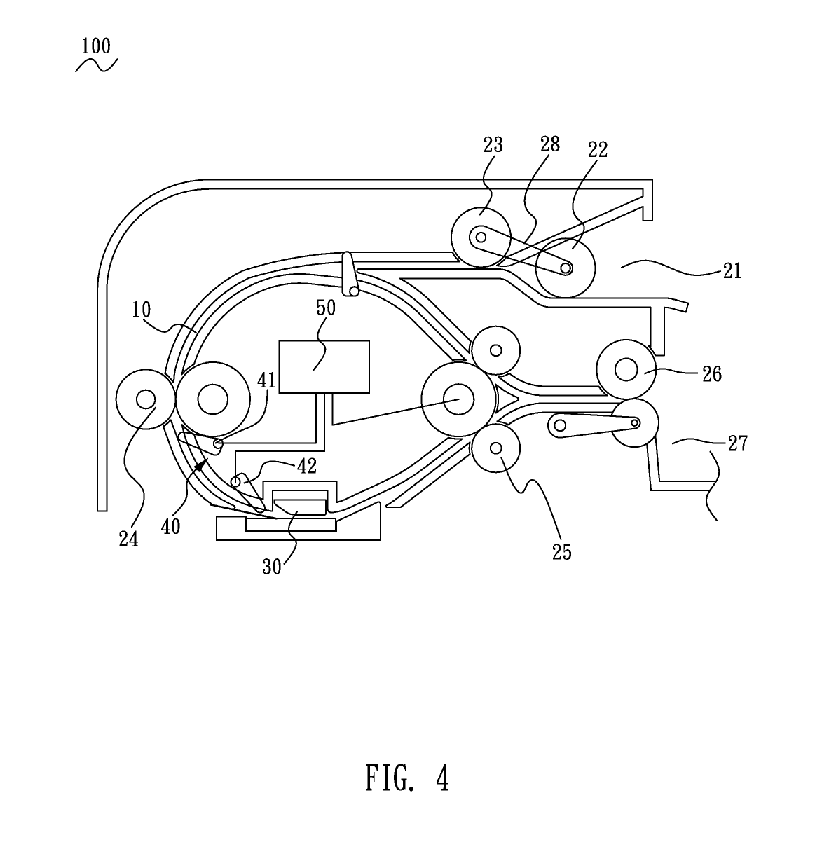

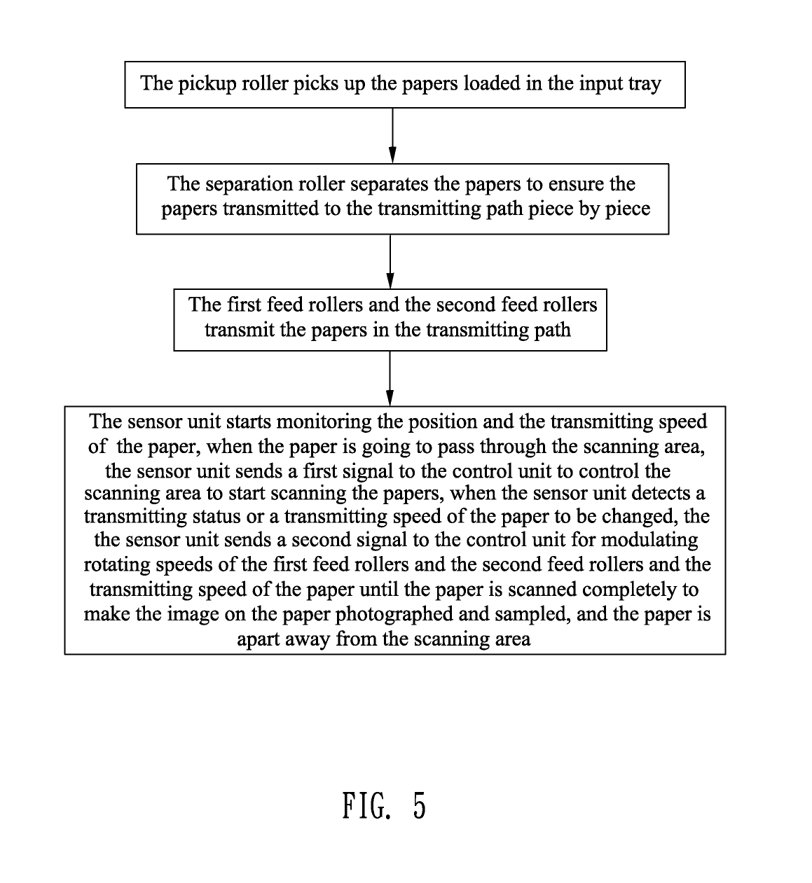

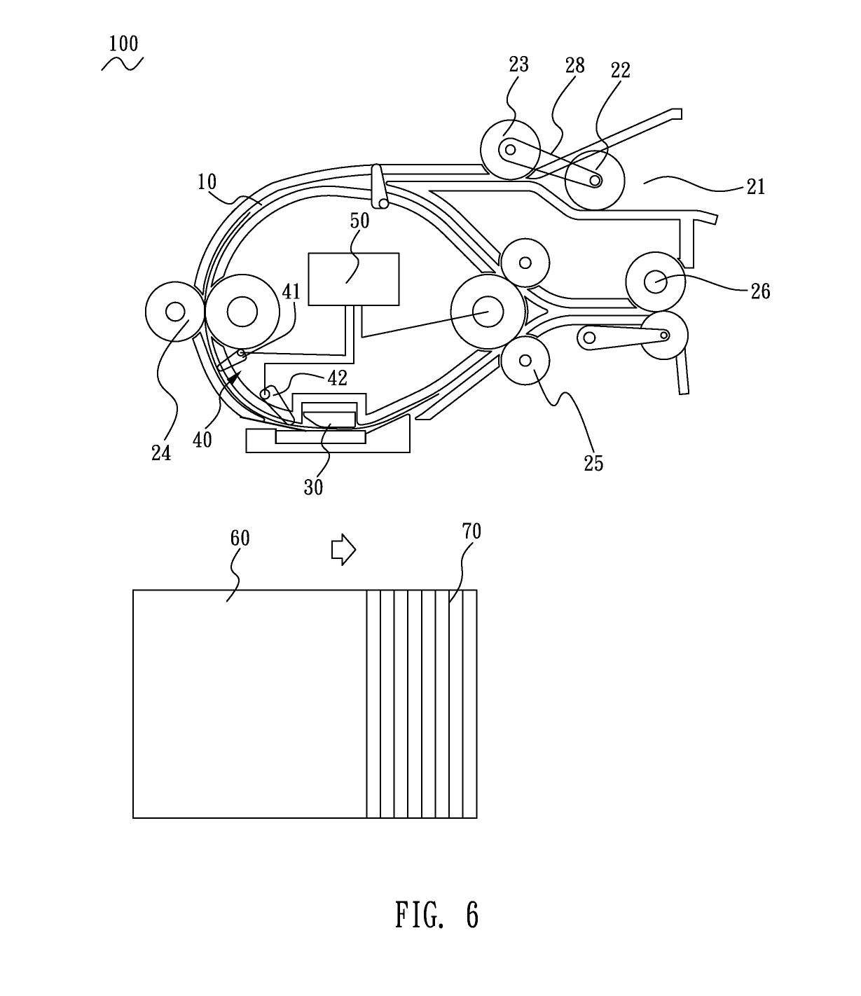

With reference to FIG. 4, FIG. 5 and FIG. 6, an image correction device 100 in accordance with an embodiment of the present invention is shown. The image correction device 100 is adapted for being applied to an automatic feed type scanner (not shown). The automatic feed type scanner defines a transmitting path 10 for feeding papers. The image correction device 100 includes an input tray 21 disposed adjacent to the transmitting path 10 for loading the papers 60 therein, a pickup roller 22 disposed above the input tray 21 for picking up the papers 60, a separation roller 23 disposed to an entry end of the transmitting path 10 for separating the papers 60 to ensure the papers 60 transmitted to the transmitting path 10 piece by piece, a plurality of first feed rollers 24 disposed in upstream of the transmitting path 10 for transmitting the papers 60 in the transmitting path 10, a plurality of second feed rollers 25 disposed in downstream of the transmitting path 10 for transmitting the papers 60 in the transmitting path 10, a scanning area 30 disposed to the transmitting path 10 and located between the first feed rollers 24 and the second feed rollers 25 for scanning papers 60, a sensor unit 40 disposed to the transmitting path 10 for detecting a position of the paper 60 and a distance between each two pieces of paper 60, a control unit 50 electrically connecting with the sensor unit 40 and controlling rotating speeds of the first feed rollers 24 and the second feed rollers 25 according to signals sending by the sensor unit 40, a plurality of paper-out rollers 26 disposed to an exit end of the transmitting path 10 for transmitting the paper 60 out of the transmitting path 10, a paper-out tray 27 disposed under the paper-out rollers 26 to load the paper 60 transmitted out of the transmitting path 10, a linkage mechanism (not shown) and a stepper motor (not shown).

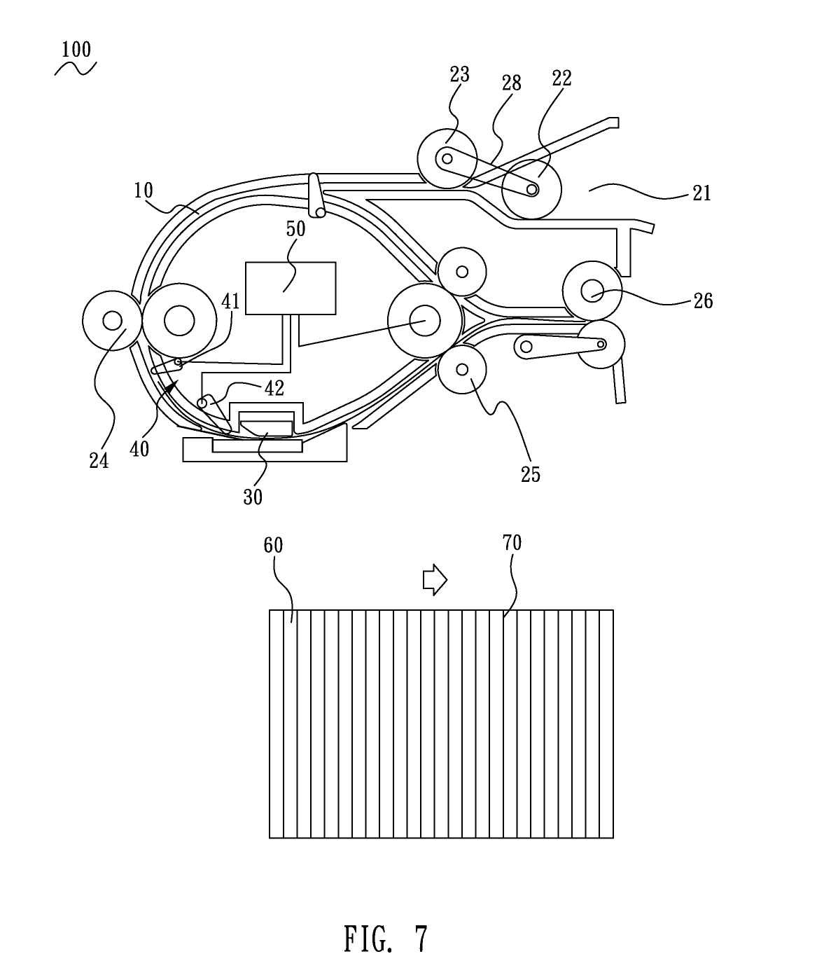

Referring to FIG. 4, FIG. 5, FIG. 6 and FIG. 7, the pickup roller 22 and the separation roller 23 are linked by a transmitting element 28. A distance between the first feed rollers 24 and the second feed rollers 25 is less than a length of the paper 60. The first feed rollers 24 and the second feed rollers 25 are via the linkage mechanism to be driven by the stepper motor. The stepper motor is electrically connected with the control unit 50 to change rotating speeds and directions of the stepper motor according to different input currents to control rotating speeds of the first feed rollers 24 and the second feed rollers 25 so as to control transmitting speed of the paper 60.

Referring to FIG. 4 and FIG. 6, in this embodiment, the sensor unit 40 includes a paper releasing sensor 41 and a scan sensor 42. The paper releasing sensor 41 is disposed adjacent to the first feed rollers 24 for detecting the distance between each two pieces of paper 60 and whether the paper 60 has passed through the first feed rollers 24. And the scan sensor 42 is disposed adjacent to the scanning area 30 for detecting whether the papers 60 have passed through the scanning area 30.

Referring to FIG. 4, FIG. 5, FIG. 6 and FIG. 7, when the image correction device 100 starts scanning, an image correction method of image correction device 100 is provided, and steps of the image correction method of image correction device 100 are described as follows. Firstly, the pickup roller 22 picks up the papers 60 loaded in the input tray 21. Secondly, the separation roller 23 separates the papers 60 to ensure the papers 60 transmitted to the transmitting path 10 piece by piece. Thirdly, the first feed rollers 24 and the second feed rollers 25 transmit the papers 60 in the transmitting path 10. Fourthly, simultaneously, the sensor unit 40 disposed to the transmitting path 10 starts monitoring the position and the transmitting speed of the paper 60. When the paper 60 is going to pass through the scanning area 30, the sensor unit 40 sends a first signal to the control unit 50 to control the scanning area 30 to start scanning the papers 60. When the papers 60 pass through the scanning area 30, the scanning area 30 retrieves one line of image perpendicular to a direction of transmitting the papers 60. The one line of the image is designated as a scanning line 70. Because the scanning area 30 photographs and samples the image on the paper 60 at a constant frequency, a distance between each two scanning lines 70 is constant. When the sensor unit 40 detects a transmitting status or a transmitting speed of the paper 60 to be changed, the sensor unit 40 sends a second signal to the control unit 50 for modulating rotating speeds of the first feed rollers 24 and the second feed rollers 25 and the transmitting speed of the paper 60 until the paper 60 is scanned completely to make the image on the paper 60 photographed and sampled, and the paper 60 is apart away from the scanning area 30. Then the scanning lines 70 are combined into a complete image by virtue of a subsequent procession. After completing scanning the image on the paper 60, the first feed rollers 24 and the second feed rollers 25 further transmit the papers 60 to the paper-out rollers 26 and the paper-out rollers 26 transmit the paper 60 to the paper-out tray 27.

Referring to FIG. 4, FIG. 5, FIG. 6 and FIG. 7, in this embodiment, in order to avoid the combined image generating an abnormal proportion after the paper 60 is apart away from the first feed rollers 24 to accelerate the first feed rollers 24, so it needs to distinguish a time point of the paper 60 passing through the scanning area 30 at a normal speed between a time point of the paper 60 passing through the scanning area 30 at an accelerating speed. Specific description of the image correction method of image correction device 100 is described as follows.

Referring to FIG. 4, FIG. 5, FIG. 6 and FIG. 7, the paper 60 is transmitted in the transmitting path 10, and is transmitted to be under the scanning area 30 by the first feed rollers 24 and the second feed rollers 25. A rotating speed of the second feed roller 25 is faster than that of the first feed roller 24 and the distance between the first feed rollers 24 and the second feed rollers 25 is less than the length of the paper 60, so when one end of the paper 60 is clipped between the first feed rollers 24 and the other end of the paper 60 is clipped between the second feed rollers 25 to keep a surface of the paper 60 flat under a tension action between the first feed rollers 24 and the second feed rollers 25 so as to facilitate the scanning area 30 to scan the paper 60.

When the paper 60 is going to pass through the scanning area 30, the paper 60 will trigger the scan sensor 42 which is located adjacent to the scanning area 30, and the scan sensor 42 sends the first signal to the control unit 50. After the control unit 50 receives the first signal, the scanning area 30 is started to scan the paper 60. With the movement of the paper 60, the scanning area 30 retrieves the image on the paper 60 at a constant frequency to be a plurality of lines of scanning lines 70. At the moment, the paper 60 moves with a constant speed, so a distance between each two lines of scanning lines 70 keeps equal.

When a tail edge of the paper 60 breaks away from the first feed rollers 24, the paper 60 is only brought along by the second feed roller 25 to pass through the scanning area 30 with a high speed. A distance between each two lines of the scanning lines 70 will be lengthened. In order to keep an equal distance between each two lines of the scanning lines 70, when the paper releasing sensor 41 detects the tail edge of the paper 60 to break away from the first feed rollers 24, the paper releasing sensor 41 sends the second signal to the control unit 50. When the control unit 50 receives the second signal, the control unit 50 will lower a rotating speed of the stepper motor, so that the rotating speed of the second feed roller 25 is lowered to maintain a constant transmitting speed of the paper 60 for effectively preventing the transmitting speed of the paper 60 from becoming overly faster to generate an abnormality.

Referring to FIG. 4, FIG. 5, FIG. 6 and FIG. 7, a method of changing the rotating speeds of the first feed rollers 24 and the second feed rollers 25 is provided. Steps of changing the rotating speeds of the first feed rollers 24 and the second feed roller 25 are described as follows.

Firstly, the scan sensor 42 of the sensor unit 40 detects a front edge of the paper 60, and the front edge of the paper 60 triggers the scan sensor 42 of the sensor unit 40 to make the sensor unit 40 send the first signal to the control unit 50.

Secondly, when the control unit 50 receives the first signal, the control unit 50 controls the scanning area 30 to start scanning the paper 60;

Thirdly, when the paper releasing sensor 41 of the sensor unit 40 detects the tail edge of the paper 60 to break away from the first feed rollers 24, and the scan sensor 42 of the sensor unit 40 detects the paper 60, at the moment, the paper releasing sensor 41 sends the second signal to the control unit 50.

Fourthly, when the control unit 50 receives the second signal, the control unit 50 is going to control the rotating speed of the second feed roller 25 to be lowered to maintain a constant transmitting speed of the paper 60.

As described above, the image correction device 100 modulates rotating speeds of the first feed rollers 24 and the second feed rollers 25 by virtue of the sensor unit 40 detecting the position of the paper 60 for effectively preventing the transmitting speed of the paper 60 from being changed. Comparing with the prior art, the image correction device 100 in accordance with the present invention needs no extra device, and it effectively prevents the image correction device 100 generates an error after the image correction device 100 being used to generate an abrasion. Therefore, the image correction device 100 is apt to manufacture and maintain and an image correction method of the image correction device 100 is provided.

What is claimed is:

1. An image correction device adapted for being applied to an automatic feed type scanner, the automatic feed type scanner defining a transmitting path for feeding papers, the image correction device comprising:
an input tray disposed adjacent to the transmitting path for loading the papers therein;
a pickup roller disposed above the input tray for picking up the papers;
a separation roller disposed to an entry end of the transmitting path for separating the papers to ensure the papers transmitted to the transmitting path piece by piece;
a plurality of first feed rollers disposed in upstream of the transmitting path for transmitting the papers in the transmitting path;
a plurality of second feed rollers disposed in downstream of the transmitting path for transmitting the papers in the transmitting path;
a scanning area disposed to the transmitting path and located between the first feed rollers and the second feed rollers for scanning papers;
a sensor unit disposed to the transmitting path for detecting a position of the paper and a distance between each two pieces of paper;
a control unit electrically connecting with the sensor unit and controlling rotating speeds of the first feed rollers and the second feed rollers according to signals sending by the sensor unit;
a plurality of paper-out rollers disposed to an exit end of the transmitting path for transmitting the paper out of the transmitting path; and
a paper-out tray disposed under the paper-out rollers to load the paper transmitted out of the transmitting path.

2. The image correction device as claimed in claim 1, wherein the sensor unit includes a paper releasing sensor and a scan sensor, the paper releasing sensor is disposed adjacent to the first feed rollers for detecting the distance between each two pieces of paper and whether the paper has passed through the first feed rollers, and the scan sensor is disposed adjacent to the scanning area for detecting whether the papers have passed through the scanning area.

3. The image correction device as claimed in claim 1, wherein a distance between the first feed rollers and the second feed rollers is less than a length of the paper.

4. An image correction method of image correction device as claimed in claim 1, comprising the steps of:
the pickup roller picking up the papers loaded in the input tray;
the separation roller separating the papers to ensure the papers transmitted to the transmitting path piece by piece;
the first feed rollers and the second feed rollers transmitting the papers in the transmitting path; and
the sensor unit starting monitoring the position and the transmitting speed of the paper, when the paper is going to pass through the scanning area, the sensor unit sending a first signal to the control unit to control the scanning area to start scanning the papers, when the sensor unit detects a transmitting status or a transmitting speed of the paper to be changed, the sensor unit sending a second signal to the control unit for modulating rotating speeds of the first feed rollers and the second feed rollers and the transmitting speed of the paper until the paper is scanned completely to make the image on the paper photographed and sampled, and the paper is apart away from the scanning area.

5. A method of changing the rotating speeds of the first feed rollers and the second feed rollers as claimed in claim 4, comprising the steps of:
the sensor unit detecting a front edge of the paper, and the front edge of the paper triggering the sensor unit to make the sensor unit send the first signal to the control unit;
when the control unit receives the first signal, the control unit controlling the scanning area to start scanning the paper;
when the sensor unit detects the tail edge of the paper to break away from the first feed rollers, the sensor unit sending the second signal to the control unit; and
when the control unit receives the second signal, the control unit being going to control the rotating speed of the second feed roller to be lowered to maintain a constant transmitting speed of the paper.

6. The method as claimed in claim 5, wherein the sensor unit includes a scan sensor disposed adjacent to the scanning area, the scan sensor of the sensor unit detects the front edge of the paper, and the front edge of the paper triggers the scan sensor of the sensor unit to make the sensor unit send the first signal to the control unit.

7. The method as claimed in claim 5, wherein the sensor unit includes a paper releasing sensor disposed adjacent to the first feed rollers and a scan sensor disposed adjacent to the scanning area, when the paper releasing sensor detects the tail edge of the paper to break away from the first feed rollers, and the scan sensor of the sensor unit detects the paper, at the moment, the paper releasing sensor sends the second signal to the control unit.
